(19) United States
(12) Patent Application Publication
(10) Pub. No.: US 2015/0028015 A1
(43) Pub. Date: Jan. 29, 2015

(54) HEATING SYSTEM FOR STEERING WHEEL

(71) Applicants: Youngmin Hi-Tech Co., Ltd., Asan-si (KR); Hyundai Motor Company, Seoul (KR)

(72) Inventors: Sang Don PARK, Anyang-si (KR); Han Bae, Suwon-si (KR); Heui Geon Lee, Anyang-si (KR); Doo-Kwon Go, Seongnam-si (KR); Pil Gu Yu, Cheonan-si (KR)

(73) Assignees: Youngmin Hi-Tech Co., Ltd., Asan-si (KR); Hyundai Motor Company, Seoul (KR)

(21) Appl. No.: 14/079,168

(22) Filed: Nov. 13, 2013

(30) Foreign Application Priority Data
Jul. 24, 2013 (KR) 10-2013-0087359

(51) Int. Cl. B62D 1/06; H05B 1/02

(52) U.S. Cl. CPC B62D 1/065; H05B 1/0236
USPC 219/204

(57) ABSTRACT

A heating system for a steering wheel includes a rim is covered with different materials having a leather part and a wood grain part. The heating system includes a first heating body provided in the leather part and a second heating body is provided in the wood grain part. A power supply is connected with the first and second heating bodies so as to supply electric power thereto. A controller has a target temperature set for the first and second heating bodies and serves to, if the steering wheel needs to be heated, control the power supply to sequentially apply maximum electric power to the first and second heating bodies so as to regulate the heating operation of the first and second heating bodies.

### CROSS-REFERENCE TO RELATED APPLICATION

The present application claims priority of Korean Patent Application Number 10-2013-0087359 filed Jul. 24, 2013, the entire contents of which application is incorporated herein for all purposes by this reference.

### BACKGROUND OF INVENTION

1. Field of Invention

The present invention relates, in general, to a heating system for a steering wheel, which provides a steering wheel with a heating function so that a surface of the steering wheel can be rapidly heated if required.

2. Description of Related Art

Generally, a vehicle has a heating apparatus which provides the inside of the vehicle with a warm environment so as to provide comfort to vehicle occupants who get into the vehicle in a cold environment.

Such a heating apparatus generally includes a heater which discharges warm air using heat from engine cooling water, the temperature of which gradually increases as a vehicle starts, and from exhaust gas, and from a seat heater which has a heating coil installed in a seat so as to maintain a warm seat while electric power is supplied.

In addition to these heaters, there is also a steering wheel heater which increases the temperature of a steering wheel that has become cold during cold conditions such as below zero temperatures.

In the meantime, as design for a vehicle is considered important, the design for a steering wheel is also receiving attention. For an improvement in the design of a steering wheel, in some cases, the rim of the steering wheel is covered with a wood grain piece in part as well as a leather sheet cover.

Referring to FIG. 1, in a case of a steering wheel which has a leather part 100 and a wood grain part 200, the two parts need to be respectively applied with electric power so as to increase the temperature of the wheel. However, such a steering wheel has problems of reduced heating capability because the leather part 100 and the wood grain part 200 should be heated using restricted electric power. To solve these problems, increased electric power can be applied in order to improve the heating capability. However, to this end, wiring in the steering roll connector needs to be further developed, and even if it has been developed, the development also causes high power consumption and therefore an increase in a risk of fire.

Further, in the case of a steering wheel composed of different materials, the temperature of the steering wheel does not uniformly increase owing to a difference in physical properties of the materials used in its construction.

Thus, there is a need to develop a heating apparatus for a steering wheel which is capable of rapidly and uniformly increasing the temperature of the steering wheel using rated power even if the steering wheel is composed of different materials.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Accordingly, the present invention has been made keeping in mind the above problems occurring in the related art, and the present invention is intended to propose a heating system for a steering wheel which is capable of uniformly and rapidly increasing the temperature of an entire steering wheel composed of different materials, including a wood grain part and a leather part, using rated power.

Various aspects of the present invention provide for a heating system for a steering wheel of which a rim is covered with different materials including a leather part and a wood grain part, the heating system including: a first heating body provided in the leather part so as to provide heat through electric power; a second heating body provided in the wood grain part so as to provide heat through electric power; a pair of temperature sensors provided in the steering wheel so as to check the temperatures of the leather part and the wood grain part, respectively; a power supply connected with the first and second heating bodies so as to supply electric power thereto; and a controller having a target temperature set for the first and second heating bodies and serving to, if the steering wheel needs to be heated, control the power supply to sequentially apply maximum electric power to the first and second heating bodies so as to regulate a heating operation of the first and second heating bodies.

The wood grain part may be formed partly around an upper portion of the rim, and the leather part may be formed around the remaining portion of the rim.

The controller may control the power supply to firstly apply electric power to the first heating body and to secondarily apply electric power to the second heating body after a certain time has elapsed.

The controller may control the power supply to, if there is a difference in temperature between the leather part and the wood grain part during an increase in temperature of the steering wheel, apply electric power to the heating body at either part in a relatively low temperature for increased time relative to the heating body of the other part.

The controller may control the power supply to, if either the leather part or the wood grain part reaches the target temperature before the other, concentrate electric power to the heating body of the other part that has not reached the target temperature.

The target temperature may have a middle target temperature and a final target temperature; the controller may check whether or not the leather part and the wood grain part reach the respective target temperatures, and the controller may control the power supply to, if either the leather part or the wood grain part reaches the target temperature, concentrate electric power to the heating body of the other part that has not reached the target temperature.

The controller may check whether or not the first or second heating body has failed, using the temperature of the first or second heating body, and if a failure has been detected, the controller may display an alert message.

According to another aspect of the present invention, there is provided a method of heating a steering wheel composed of different materials including a leather part and a wood grain part, wherein the leather part and the wood grain part have therein first and second heating bodies, respectively, providing heat using electric power supplied, the method including: determining whether or not the steering wheel needs to be heated; if the steering wheel needs to be heated, firstly applying maximum electric power to the first heating body using a power supply; after some time has elapsed, interrupting application of electric power to the first heating body and in turn secondarily applying maximum electric power to the second heating body; and thirdly sequentially applying maximum electric power to the first and second heating bodies so as to increase temperature of the leather part and the wood grain part to the target temperature.

If there is a difference in temperature between the leather part and the wood grain part, the third heating stage may further include increasing a length of time in which electric power is supplied to the heating body of either the leather part or the wood grain part to heat the part in a relatively low temperature.

According to the heating system for a steering wheel, maximum electric power is sequentially applied to the first and second heating bodies, which are disposed in the leather part and the wood grain part, respectively, so that the temperature of the leather part and the wood grain part can be rapidly increased.

Further, the length of time to supply electric power to the leather part and the wood grain part is regulated, so that the temperature of the leather part and the wood grain part can be uniformly increased.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a steering wheel composed of a leather part and a wood grain part;

FIG. 2 is a configuration of an exemplary heating system for a steering wheel according to the present invention; and

FIG. 3 is a flow chart showing an exemplary procedure of heating a steering wheel according to the present invention.

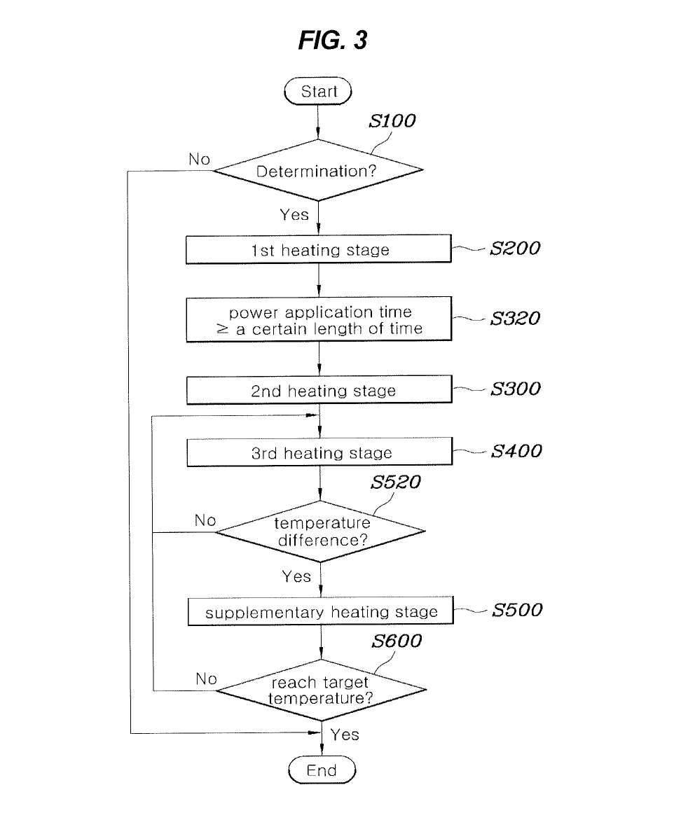

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

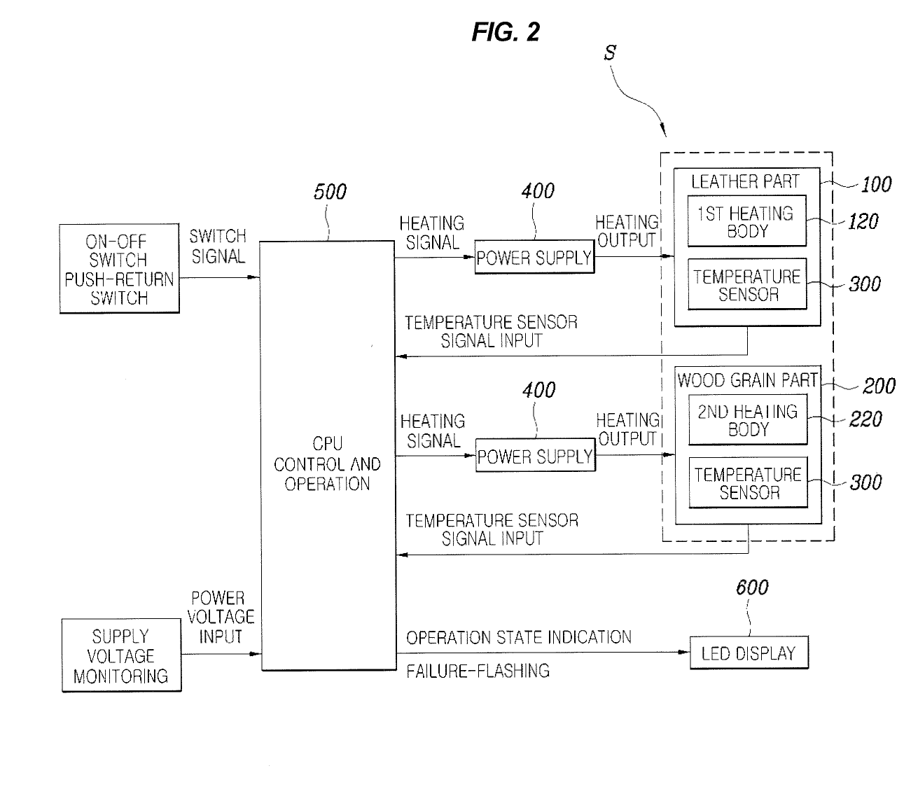

FIG. 2 is a configuration of a heating system for a steering wheel according to various embodiments of the present invention.

In the description and drawings, a power switch for turning on/off the heating system for a steering wheel, a steering roll connector, and other parts are well-known conventional elements to heat the steering wheel, so a detailed configuration thereof will not be described and illustrated.

The steering wheel S to which the heating system is adapted has a rim which is covered with different materials including a leather part 100 and a wood grain part 200. The heating system includes: a first heating body 120 which is provided in the leather part 100 so as to provide heat through electric power; a second heating body 220 which is provided in the wood grain part 220 so as to provide heat through electric power; a pair of temperature sensors 300 which are provided in the steering wheel S so as to check the temperatures of the leather part 100 and the wood grain part 200, respectively; a power supply 400 which is connected with the first and second heating bodies 120 and 220 so as to supply electric power thereto; and a controller 500 which has a target temperature set for the first and second heating bodies 100 and 200 and which serves to, if the steering wheel S needs to be heated, control the power supply 400 to sequentially apply maximum electric power to the first and second heating bodies 120 and 220 so as to regulate the heating operation of the first and second heating bodies 120 and 220.

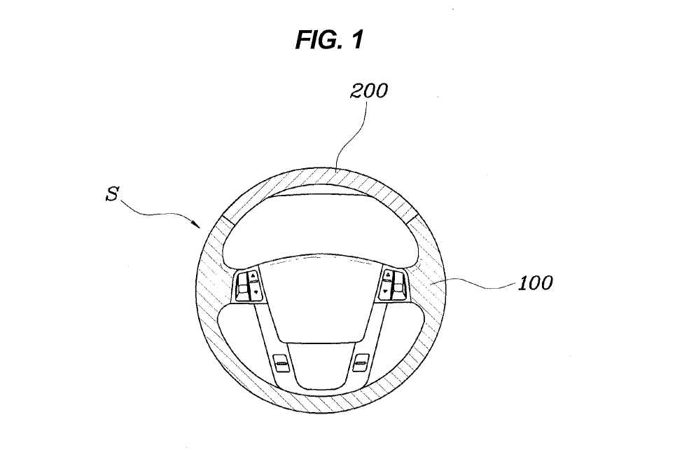

Specifically, as shown in FIG. 1, the wood grain part 200 may be formed partly around an upper portion of the rim, and the leather part 100 may be formed around the remaining portion of the rim. Although an area of the wood grain part 200 may be increased in the rim of the steering wheel S, the wood grain part may be positioned in the rim such that, when the steering wheel S is held by the hands of a driver, his or her hands are positioned on the side of the leather part 100, because the wood grain part 200 is provided for an improvement in the design of the steering wheel S, and gripping ergonomics is better at the leather part 200 than at the wood grain part 200.

The first and second heating bodies 120 and 220, which are provided in the leather part 100 and the wood grain part 200, respectively, may include inner heating coils or outer heating coatings. However, since in the present invention, the first and the second heating bodies 120 and 220 are selectively applied with electric power under the control of the controller 500 so as to regulate the temperature of the leather part 100 and the wood grain part 200, the first and second heating bodies 120 and 220 may adopt heating coils which are activated via electric connection.

Each of the temperature sensors 300 installed in the leather part 100 and the wood grain part 200 outputs a resistance value varying depending on temperature to the controller 500. In this way, when receiving information about the temperature of the leather part 100 and the wood grain part 200, the controller 500 determines whether or not the temperatures of the respective parts 100 and 200 have reached a target temperature, or checks a difference in temperature between the respective parts 100 and 200, and based on the result, controls the heating operation of the first and second heating bodies 120 and 220.

The power supply 400 is activated by the battery of a vehicle and is configured to be electrically connected with the first and second heating bodies 120 and 220 so as to selectively supply electric power to the first and second heating bodies 120 and 220 under the control of the controller 500.

The controller 500 has a target temperature set for the leather part 100 and the wood grain part 200. Here, the target temperatures set for the leather part 100 and the wood grain part 200 may be the same or be different from each other, and may be diversely set according to specifications of the steering wheel S. In order to enable the temperatures of the respective parts 100 and 200 to reach their respective target temperatures, the controller 500 controls the power supply 400 to apply electric power to the first and second heating bodies 120 and 220. Here, according to the present invention, the power supply does not apply electric power at the same time to the first and second heating bodies 120 and 220, but alternately applies maximum electric power to the respective heating bodies 120 and 220.

That is, the controller 500 applies maximum electric power to the first heating body 120 within rated power, and after a certain time has elapsed, interrupts the application of electric power to the first heating body 120 and in turn applies maximum electric power to the second heating body 220 in a repetitive manner. In this way, the heating bodies 120 and 220 of the respective parts 100 and 200 are sequentially supplied with electric power, so that the temperatures of the respective parts can be rapidly increased owing to residual heat effects by applied electric power.

Compared to continuous application of low electric power to the respective parts in a conventional heating system for a steering wheel S, the present heating system can improve heating efficiency for a steering wheel by sequentially applying maximum electric power to the respective parts.

Here, the time elapsed may be a short time within 0.5 second, or a time of 5 seconds or more. The time elapsed may be set according to the temperatures of the leather part 100 and the wood grain part 200.

The controller 500 may also control the power supply 400 to firstly apply electric power to the first heating body 120 and to secondarily apply electric power to the second heating body 220 after a certain time elapsed.

In the present invention, the first heating body 120 is installed in the leather part 100, and the second heating body 220 is installed in the wood grain part 200. As shown in FIG. 1, the leather part 100 occupies the most area of the rim of the steering wheel S except the upper portion of the rim so that, when a driver holds the steering wheel S, the hands of the driver are positioned around the leather part 100.

Further, due to the nature of the material, the temperature of the leather part 100 is easily increased relative to the temperature of the wood grain part 200. Thus, electric power is first applied to the first heating body 120 so as to rapidly heat the leather part 100, so that a driver can feel a rapid increase in temperature of the steering wheel S.

If there is a difference in temperature between the leather part 100 and the wood grain part 200 while the temperature of the steering wheel S is being increased, the controller 500 can increase the time to apply electric power to the heating body of whichever part has a lower temperature.

As described above, due to the nature of the materials, the leather part 100 and the wood grain part 200 of the steering wheel S have different temperature-increase times. Further, there may be a difference in temperature between the leather part and the wood grain part because either the leather part 100 or the wood grain part 200 has increased in temperature more than the temperature of the other according to sequential application of maximum electric power to the heating bodies 120 and 220 of the respective parts 100 and 200. Further, while a driver holds the steering wheel S, the entire rim of the steering wheel S may not be uniformly temperature-increased due to the body temperature of the driver.

If there is a difference in temperature between the leather part 100 and the wood grain part 200 due to external factors and environment, the length of time to apply electric power to the heating body in a relatively low temperature is increased so that the temperature of the corresponding heating body can be rapidly increased.

For example, although the leather part 100 and the wood grain part 200 of the steering wheel S are alternately applied with electric power for the same time, due to the nature of the materials, the temperature of the leather part 100 can be rapidly increased relative to the temperature of the wood grain part 200. Then, the temperature sensors 300 installed in the leather part 100 and the wood grain part 200, respectively, detect this, and send relevant temperature information to the controller 500 so that the controller 500 can determine whether or not a difference in temperature between the leather part 100 and the wood grain part 200 is outside a predefined range.

If the temperature of the leather part 100 is higher than that of the wood grain part 200, so that a difference in temperature therebetween is outside a predetermined range, the controller 500 controls the power supply 400 to interrupt the application of electric power to the first heating body 120 of the leather part 100, and to apply electric power to the second heating body 220 of the wood grain part 200 so that the temperature of the wood grain part 200 can be rapidly increased.

Alternatively, the first and second heating bodies 120 and 220 are alternately applied with electric power such that, if the temperature of the leather part 100 is higher than that of the wood grain part 200, the length of time to apply electric power to the first heating body 120 is decreased, and the length of time to apply electric power to the second heating body 220 is increased, thereby gradually and uniformly balancing the temperatures of the leather part 100 and the wood grain part 200.

If there is a difference in temperature between the leather part 100 and the wood grain part 200, the magnitude of electric power applied to and the length of time to apply electric power to the first and second heating bodies 120 and 220 are regulated so that the difference in temperature between the respective parts can be eliminated.

If either the leather part 100 or the wood grain part 200 reaches a target temperature, the controller 500 may control the power supply to concentrate electric power to the heating body of the other part that has not reached the target temperature.

That is, as the first and second heating bodies 120 and 220 are supplied with electric power, the temperatures of the leather part 100 and the wood grain part 200 increase such that either the leather part 100 or the wood grain part 200 first reaches the target temperature because of external factors and a difference in physical properties. Then, the application of electric power to either of the heating bodies which has reached the target temperature is temporarily interrupted, and electric power is concentrated to the other heating body which has not reached the target temperature so that the corresponding heating body can be rapidly heated to the target temperature.

According to the present invention, the heating bodies of the leather part 100 and the wood grain part 200 are sequentially supplied with electric power, so that the temperatures of the respective parts increase similarly. Thus, the difference in the length of time to reach the target temperature is not great.

Thus, the length of time to apply electric power to the heating body which has not reached the target temperature is not long, so there is no problem with respect to failure and durability due to the concentrated application of electric power.

When all of the leather part 100 and the wood grain part 200 are heated to the respective target temperatures thereof under such control, the heating bodies 120 and 220 of the respective parts 100 and 200 are in turn sequentially supplied with electric power, thereby preventing a difference in temperature therebetween from occurring.

Here, the target temperature may have a middle target temperature and a final target temperature, the controller 500 may check whether or not the leather part 100 and the wood grain part 200 reach the target temperatures, respectively, and the controller 500 may control the power supply to, if either of the leather part 100 and the wood grain part 200 reaches the target temperature, concentrate electric power to the heating body of the other part that has not reached the target temperature.

In this way, the target temperature consists of the middle target temperature and the final target temperature, and the middle temperature and the final target temperature of the leather part 100 and the wood grain part 200 are set to the same temperatures, respectively, so that the leather part 100 and the wood grain part 200 can be uniformly heated.

The controller 500 may check whether or not the first or second heating body 120 or 220 has failed using the temperature of the first or second heating body, and if a failure has been detected, the controller 500 may display an alert message.

That is to say, in a case where the first or second heating body 120 or 220 is interrupted from being supplied with electric power, or has failed due to an overvoltage, the driver can be informed of such failures of the steering wheel S. To this end, a flashing display 600 can be provided on an instrument panel.

If there is a failure in the first or second heating body 120 or 220 of the steering wheel S, continuous application of electric power thereto may cause an accident such as overheating or a short circuit, so that an error sign may be signaled to an instrument panel and the heating operation of the steering wheel is interrupted.

According to another aspect of the present invention, there is provided a method of heating a steering wheel composed of different materials including a leather part and a wood grain part, wherein the leather part and the wood grain part have therein first and second heating bodies, respectively, providing heat using electric power supplied. The method includes: determining whether or not the steering wheel needs to be heated (S100); if the steering wheel needs to be heated, firstly applying maximum electric power to the first heating body using a power supply (S200); after a certain time has elapsed (S320), interrupting the application of electric power to the first heating body and in turn secondarily applying maximum electric power to the second heating body (S300); and thirdly sequentially applying maximum electric power to the first and second heating bodies so as to increase the temperature of the leather part and the wood grain part to a target temperature (S400).

If there is a difference in temperature between the leather part and the wood grain part, the third heating stage (S400) may further include increasing a length of time to supply electric power to the heating body of either the leather part or the wood grain part in a relatively low temperature (S500).

According to the method, the leather part and the wood grain part can be uniformly and rapidly heated to a target temperature.

According to the heating system for a steering wheel, maximum electric power is sequentially applied to the first and second heating bodies, which are disposed in the leather part and the wood grain part, respectively, so that the temperature of the leather part and the wood grain part can be rapidly increased.

Further, a length of time to apply electric power to the leather part and the wood grain part is regulated, so that the temperature of the leather part and the wood grain part can be uniformly increased.

For convenience in explanation and accurate definition in the appended claims, the terms upper, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications Thereof. It is intended that the scope of the invention be defined by the Claims appended hereto and their equivalents.

What is claimed is:

1. A heating system for a steering wheel comprising:
a rim covered with different materials including a leather part and a wood grain part;
a first heating body provided in the leather part so as to provide heat with electric power;
a second heating body provided in the wood grain part so as to provide heat through electric power;
a pair of temperature sensors provided in the steering wheel so as to check the temperature of the leather part and the wood grain part, respectively;
a power supply connected with the first and second heating bodies so as to supply electric power thereto; and
a controller having a target temperature set for the first and second heating bodies and serving to, if the steering wheel needs to be heated, control the power supply to sequentially apply maximum electric power to the first and second heating bodies so as to regulate a heating operation of the first and second heating bodies.

2. The heating system for a steering wheel according to claim 1, wherein the wood grain part is formed partly around an upper portion of the rim, and the leather part is formed around the remaining portion of the rim.

3. The heating system for a steering wheel according to claim 1, wherein the controller controls the power supply to firstly apply electric power to the first heating body and to secondarily apply electric power to the second heating body after a certain time has elapsed.

4. The heating system for a steering wheel according to claim 1, wherein the controller controls the power supply to, if there is a difference in temperature between the leather part and the wood grain part during an increase in temperature of the steering wheel, apply electric power to the heating body of either part in a relatively low temperature for increased time relative to the heating body at the other part.

5. The heating system for a steering wheel according to claim 1, wherein the controller controls the power supply to, if either the leather part or the wood grain part reaches the target temperature, concentrate electric power to the heating body of the other part that has not reached the target temperature.

6. The heating system for a steering wheel according to claim 1, wherein the target temperature has a middle target temperature and a final target temperature, the controller checks whether or not the leather part and the wood grain part reach the respective target temperatures, and the controller controls the power supply to, if either the leather part or the wood grain part reaches the target temperature, concentrates electric power to the heating body of the other part that has not reached the target temperature.

7. The heating system for a steering wheel according to claim 1, wherein the controller checks whether or not the first or second heating body has failed, using the temperature of the first or second heating body, and if a failure has been detected, displays an alert message.

8. A method of heating a steering wheel composed of different materials including a leather part and a wood grain part, wherein the leather part and the wood grain part have therein first and second heating bodies, respectively, providing heat using electric power applied, the method comprising:
determining whether or not the steering wheel needs to be heated;
if the steering wheel needs to be heated, firstly applying maximum electric power to the first heating body using a power supply;
after a certain time has elapsed, interrupting application of electric power to the first heating body and in turn secondarily applying maximum electric power to the second heating body; and
thirdly sequentially applying maximum electric power to the first and second heating bodies so as to increase temperatures of the leather part and the wood grain part to the target temperature.

9. The method according to claim 8, wherein if there is a difference in temperature between the leather part and the wood grain part, the third heating stage further comprises increasing a length of time to supply electric power to the heating body of either the leather part or the wood grain part in relatively low temperature.
